(19) United States
(12) Patent Application Publication
(10) Pub. No.: US 2026/0264905 A1
(43) Pub. Date: Sep. 10, 2026

(54) FOOD TRAY AND VACUUM SEALER INCLUDING SAME

(71) Applicant: GUANGZHOU ARGION ELECTRIC APPLIANCE CO., LTD., Guangzhou (CN)

(72) Inventors: Guoqiang Liang, Guangzhou (CN); Yuanchao Wu, Guangzhou (CN)

(21) Appl. No.: 19/540,592

(22) Filed: Feb. 14, 2026

Related U.S. Application Data
(63) Continuation of application No. PCT/CN2026/078509, filed on Feb. 11, 2026.

(30) Foreign Application Priority Data
Mar. 7, 2025 (CN) 202510270277.4

(51) Int. Cl. B65B 31/04; A47J 39/00; B29C 65/00; B65B 31/02

(52) U.S. Cl. CPC B65B 31/046; A47J 39/006; B29C 66/71; B65B 31/028

(57) ABSTRACT

A food tray and a vacuum sealer including the same. The food tray includes a base plate and a peripheral wall formed by upwardly bending an outer edge of the base plate. The base plate and the peripheral wall enclose to form a containment space. The base plate includes a recessed portion formed by depressing a central area thereof downward, and an extended portion extending outward from an outer edge of the recessed portion. The extended portion is provided with two first bosses, which are provided with first through holes therein. An upper end of each first through hole is in communication with the containment space. Each first through hole allows a conductive column of the vacuum sealer to pass through. The extended portion is provided with a second boss having a second through hole therein; or the peripheral wall is provided with a second through hole therein.

### CROSS-REFERENCE TO RELATED APPLICATION

The present disclosure is a Continuation Application of PCT Application No. PCT/CN2026/078509 filed on Feb. 11, 2026, which claims the benefit of Chinese Patent Application No. 202510270277.4, filed on Mar. 7, 2025, which is incorporated herein by reference in its entirety.

### TECHNICAL FIELD

The present disclosure relates to the technical field of vacuum sealers, and in particular, to a food tray and a vacuum sealer including the same.

### BACKGROUND

With the widespread application of vacuum preservation technology and vacuum cooking technology, chamber vacuum sealers capable of sealing liquids have become commonly used in household and commercial settings. Current chamber vacuum sealers have following problems: during a process of sealing food containing liquids, due to tilting, slipping, or rupture of a vacuum bag, as well as boiling of the liquids, the food containing liquids may spill or leak into a vacuum chamber. Since the vacuum chamber of the vacuum sealer is typically not easily detachable, it is difficult to clean, especially when the food containing liquids spills inside the vacuum chamber. Furthermore, for chamber vacuum sealers that are built into kitchen cabinetry, cleaning the vacuum chamber becomes even more challenging as it is fixed within the cabinetry.

### SUMMARY

An objective of the present disclosure is to provide a food tray and a vacuum sealer including the same. The food tray is convenient to detach and clean, which helps keep an interior of the vacuum sealer clean.

To achieve the above objective, in one aspect, the present disclosure provides a food tray for detachably installing in a vacuum chamber of a vacuum sealer. The food tray includes a base plate and a peripheral wall formed by upwardly bending an outer edge of the base plate. The base plate and the peripheral wall enclose to form a containment space for food. The base plate includes a recessed portion formed by depressing a central area of the base plate downward, and an extended portion formed by extending outward from an outer edge of the recessed portion. The extended portion is provided with two first bosses formed by protruding upward. Each of the first bosses is provided with a first through hole therein. An upper end of the first through hole is in communication with the containment space. The first through hole is configured to allow a conductive column of the vacuum sealer to pass through, such that an upper end of the conductive column extends into the containment space.

In some embodiments, the extended portion is provided with a second boss formed by protruding upward, and the second boss is provided with a second through hole therein. One end of the second through hole is in communication with the containment space. Another end of the second through hole is configured for connecting to a vacuum pump of the vacuum sealer.

In some embodiments, a bottom of the first boss and a bottom of the second boss are both higher than the outer edge of the recessed portion.

In some embodiments, the peripheral wall is provided with the second through hole therein. One end of the second through hole is in communication with the containment space. Another end of the second through hole is configured for connecting to the vacuum pump of the vacuum sealer.

In some embodiments, the food tray includes a bag clip, and the bag clip is installed on an inner wall of the peripheral wall.

In some embodiments, the food tray includes a temperature sensor, and the temperature sensor is installed on the recessed portion.

In some embodiments, the temperature sensor includes a temperature sensing probe and an electrode located below and electrically connected to the temperature sensing probe. The temperature sensing probe is sealingly connected to the recessed portion. The electrode extends downward through the recessed portion into the vacuum chamber.

In some embodiments, the food tray includes a load cell disposed in the vacuum chamber, and the load cell is installed on a bottom surface of the base plate.

In some embodiments, an edge of the peripheral wall is bent inward to form a flange.

In some embodiments, the base plate and the peripheral wall are integrally formed of metal or plastic.

In another aspect, the present disclosure provides a vacuum sealer, including:

a main housing provided with a vacuum chamber therein;

a lid installed on the main housing, where the lid is configured to open or close the vacuum chamber;

two conductive columns installed on the main housing, where an upper end of each of the two conductive columns extends into the vacuum chamber;

a heating bar disposed in the vacuum chamber; and

the above-mentioned food tray, where the food tray is detachably installed in the vacuum chamber, and the upper end of each of the two conductive columns passes through a respective first through hole of the food tray to electrically connect to the heating bar.

The present disclosure provides the food tray and the vacuum sealer including the same. Compared with the prior art, the beneficial effects thereof lie in:

The provided food tray includes the base plate and the peripheral wall formed by upwardly bending the outer edge of the base plate. The base plate and the peripheral wall enclose to form the containment space for food. The base plate includes the recessed portion formed by depressing the central area of the base plate downward, and the extended portion formed by extending outward from the outer edge of the recessed portion. The recessed portion is configured for collecting food. The extended portion is provided with the two first bosses formed by protruding upward. Each of the first bosses is provided with the first through hole therein. The upper end of the first through hole is in communication with the containment space. The first through hole allows installation of the conductive column, and the first boss is configured to prevent food from entering the vacuum chamber along the first through hole. Therefore, the food tray is convenient to detach and clean, which helps keep an interior of the vacuum sealer clean.

### BRIEF DESCRIPTION OF THE DRAWINGS

FIG. 1 is a first top axonometric schematic view of a food tray according to some embodiments of the present disclosure.

FIG. 2 is a top axonometric schematic view of a food tray provided with a temperature sensor according to some embodiments of the present disclosure.

FIG. 3 is a bottom axonometric schematic view of a food tray provided with a temperature sensor according to some embodiments of the present disclosure.

FIG. 4 is a first axonometric schematic view of a vacuum sealer according to some other embodiments of the present disclosure.

FIG. 5 is a second top axonometric schematic view of a food tray according to some embodiments of the present disclosure.

FIG. 6 is a second axonometric schematic view of a vacuum sealer according to some other embodiments of the present disclosure.

FIG. 7 is a top axonometric schematic view of a food tray provided with a temperature sensor and a load cell according to some embodiments of the present disclosure.

FIG. 8 is a third axonometric schematic view of a vacuum sealer according to some other embodiments of the present disclosure.

In the figures: 1, base plate; 11, recessed portion; 12, extended portion; 13, first boss; 14, first through hole; 15, second boss; 16, second through hole; 2, peripheral wall; 21, flange; 3, containment space; 4, temperature sensor; 41, temperature sensing probe; 42, electrode; 5, bag clip; 100, food tray; 200, main housing; 210, vacuum chamber; 300, lid; 400, conductive column; 500, heating bar; 600, vacuum sealer; 601, vacuum pump; and 7, load cell.

### DETAILED DESCRIPTION

The technical solutions in the embodiments of the present disclosure will be clearly and completely described below in conjunction with the drawings in the embodiments of the present disclosure. Obviously, the described embodiments are only a part of the embodiments of the present disclosure, and not all of them.

It should be understood that in the description of the present disclosure, terms indicating orientations or positional relationships such as "upper", "lower", "vertical", "horizontal", "top", "bottom", "inner", "outer", etc., are based on the orientations or positional relationships shown in the drawings, and are only for the convenience of describing the present disclosure and simplifying the description, rather than indicating or implying that the referred device or element must have a specific orientation, be constructed and operated in a specific orientation, and therefore should not be construed as limiting the present disclosure. Terms "first", "second", etc. are used for descriptive purposes only, and cannot be understood as indicating or implying relative importance or implicitly indicating the number of the indicated technical features. That is, features defined with "first", "second" may explicitly or implicitly include one or more of the features. In addition, unless otherwise specified, "plurality" means two or more.

In addition, the technical features involved in the different implementation manners of the present disclosure described below may be combined with each other as long as they do not conflict with each other.

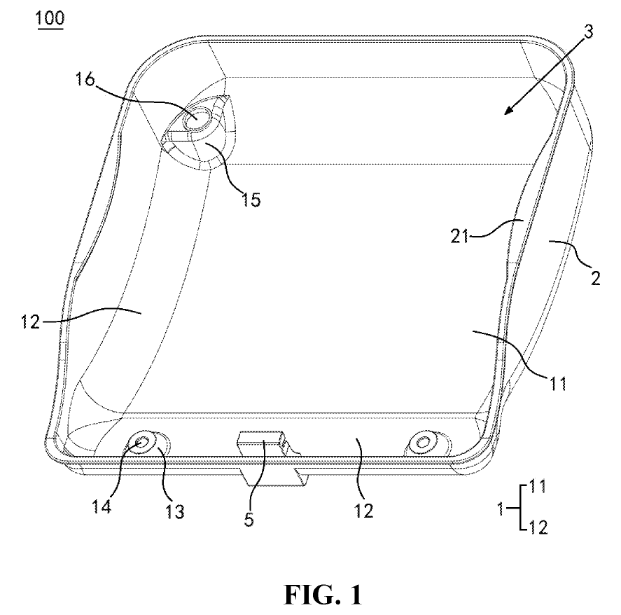

As shown in FIGS. 1 to 3, a food tray 100 according to some embodiments of the present disclosure is for detachably installing in a vacuum chamber 210 of a vacuum sealer 600. The food tray 100 includes a base plate 1 and a peripheral wall 2 formed by upwardly bending an outer edge of the base plate 1. The base plate 1 and the peripheral wall 2 enclose to form a containment space 3 for food. The base plate 1 includes a recessed portion 11 formed by depressing a central area of the base plate 1 downward, and an extended portion 12 formed by extending outward from an outer edge of the recessed portion 11. The extended portion 12 is provided with two first bosses 13 formed by protruding upward. Each of the first bosses 13 is provided with a first through hole 14 therein. An upper end of the first through hole 14 is in communication with the containment space 3. The first through hole 14 is configured to allow a conductive column 400 of the vacuum sealer 600 to pass through, such that an upper end of the conductive column 400 extends into the containment space 3. Where, the conductive column 400 is configured to supply power to a heating bar 500.

During use, a vacuum bag is placed on the base plate 1 of the food tray 100. During a process of an evacuation operation performed by the vacuum sealer 600 on the vacuum bag, any food leaking from the vacuum bag is collected in the recessed portion 11. A position of the first bosses 13 is higher than that of the recessed portion 11, preventing the conductive columns 400 from being soiled by food. After completing the evacuation operation on the vacuum bag, the food tray 100 can be detached from the vacuum chamber 210 of the vacuum sealer 600. The food collected inside the food tray 100 can be discarded, and the food tray 100 can be cleaned.

Due to the above-described structural arrangement, the food tray 100 is convenient to detach and clean, thereby maintaining an internal cleanliness of the vacuum sealer 600.

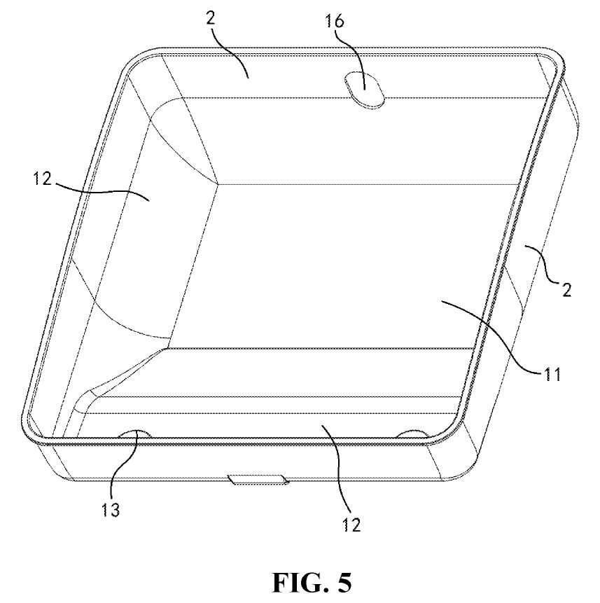

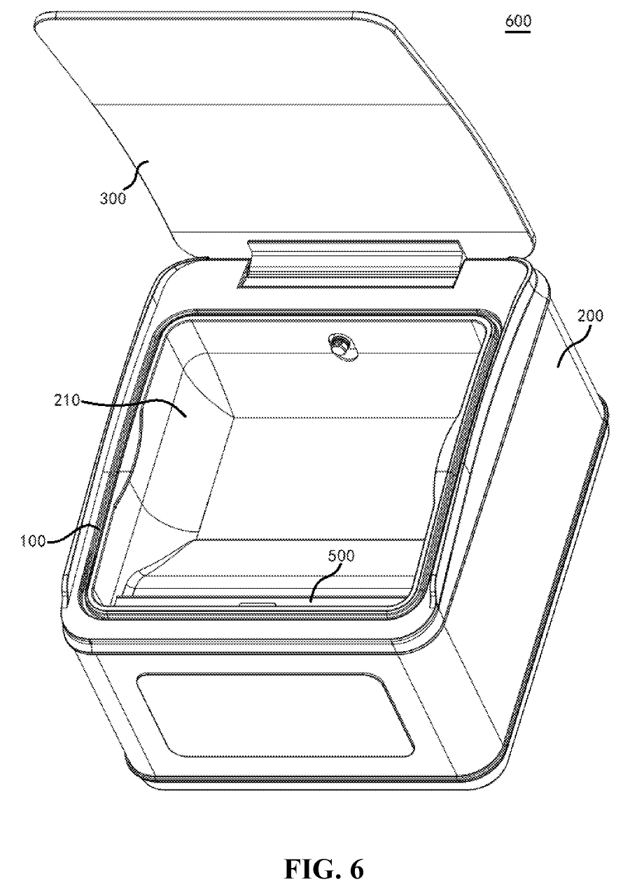

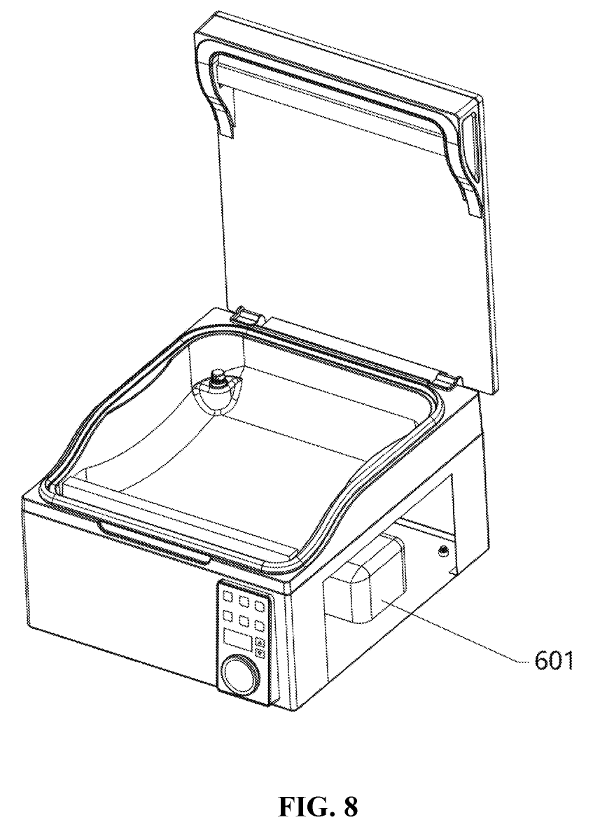

As shown in FIGS. 1, 4, and 8, in some embodiments, the extended portion 12 is provided with a second boss 15 formed by protruding upward, and the second boss 15 is provided with a second through hole 16 therein. Or, as shown in FIGS. 5 and 6, in some embodiments, the peripheral wall 2 is provided with the second through hole 16 therein. One end of the second through hole 16 is in communication with the containment space 3. Another end of the second through hole 16 is configured for connecting to a vacuum pump 601 of the vacuum sealer 600. Thus, the vacuum chamber 210 of the vacuum sealer 600 is evacuated through the second through hole 16, further placing the containment space 3 in a vacuum state, thereby enabling the evacuation operation on the vacuum bag placed within the containment space 3.

As shown in FIG. 1, in some embodiments, a bottom of the first boss 13 and a bottom of the second boss 15 are both higher than the outer edge of the recessed portion 11. Thus, food leaking from the vacuum bag during the process of the evacuation operation will flow into the recessed portion 11 and will not enter the first through holes 14 in the first bosses 13 and the second through hole 16 in the second boss 15, thereby not causing the vacuum chamber 210 of the vacuum sealer 600 to be polluted, and maintaining the internal cleanliness of the vacuum chamber 210 of the vacuum sealer 600.

As shown in FIG. 1, in some embodiments, the food tray 100 includes a bag clip 5. The bag clip 5 is installed on an inner wall of the peripheral wall 2. The bag clip 5 is configured to secure an opening of the vacuum bag, preventing the vacuum bag from sliding while keeping the opening of the vacuum bag open and flat, thereby facilitating smooth evacuation operation on the vacuum bag and ensuring a flat seal after heat-sealing of the opening of the vacuum bag. Specifically, the bag clip 5 is installed in a groove formed on the inner wall of the peripheral wall 2, or is installed on the inner wall of the peripheral wall 2 via a support post.

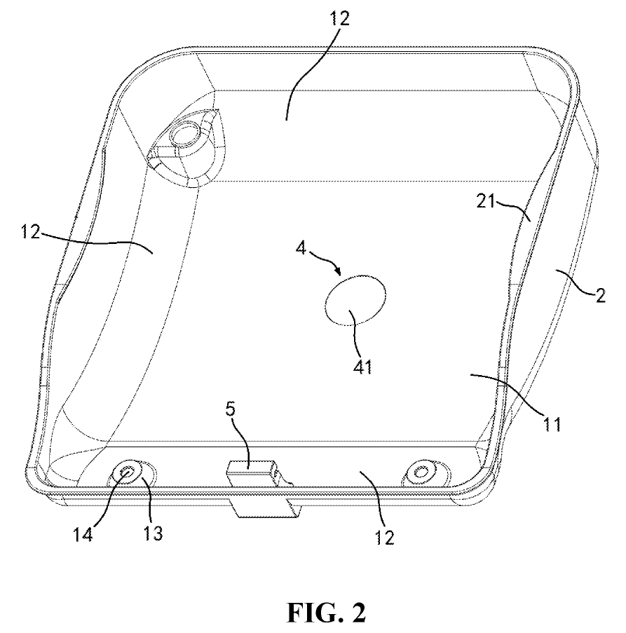

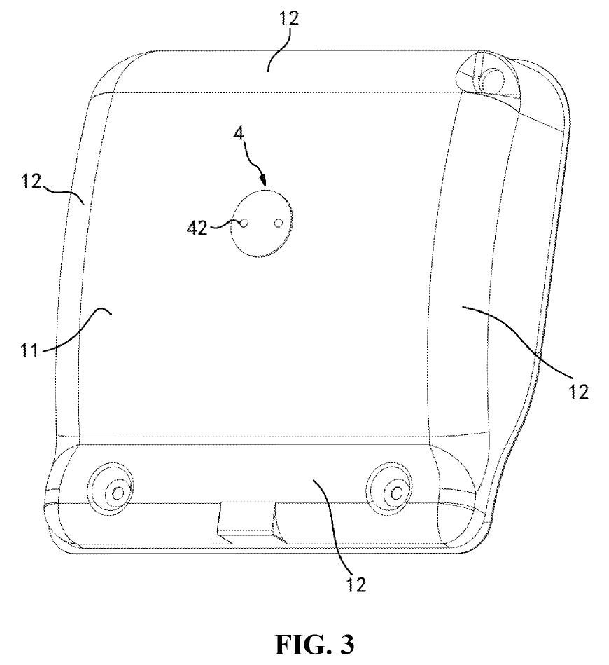

As shown in FIGS. 2 and 3, in some embodiments, the food tray 100 includes a temperature sensor 4. The temperature sensor 4 is installed on the recessed portion 11. Thus, a temperature of food within the containment space 3 can be measured by the temperature sensor 4.

As shown in FIGS. 2 and 3, in some embodiments, the temperature sensor 4 includes a temperature sensing probe 41 and an electrode 42 located below and electrically connected to the temperature sensing probe 41. The temperature sensing probe 41 is sealingly connected to the recessed portion 11, which may be achieved through sealing components (such as O-rings, sealant, etc.), to achieve sealing between the containment space 3 and the vacuum chamber 210. The electrode 42 extends downward through the recessed portion 11 into the vacuum chamber 210 of the vacuum sealer 600. Where, a portion where the electrode 42 passes through the recessed portion 11 is sealed, and the temperature sensor 4 transmits acquired temperature data to a controller of the vacuum sealer 600 for analysis and processing.

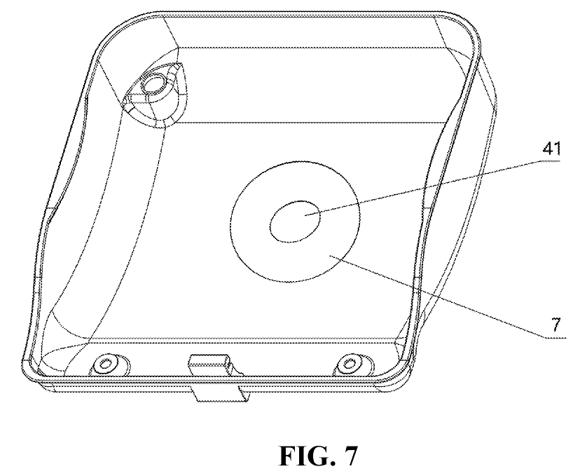

As shown in FIG. 7, in some embodiments, the food tray 100 includes a load cell 7 disposed in the vacuum chamber 210. The load cell 7 is installed on a bottom surface of the base plate 1. Thus, a weight of food placed in the containment space 3 can be measured by the load cell 7, and the load cell 7 transmits acquired weight data to the controller of the vacuum sealer 600 for analysis and processing. Where, the load cell 7 may be disposed to overlap with the temperature sensing probe 41, or may be disposed to not overlap with the temperature sensing probe 41. The load cell 7 may share the electrode 42 that is electrically connected to the temperature sensing probe 41, or may be connected to a dedicated electrode (i.e., an electrode not shared with the temperature sensing probe 41).

As shown in FIGS. 1 and 2, in some embodiments, an edge of the peripheral wall 2 is bent inward to form a flange 21. The flange 21 facilitates grasping the entire food tray 100, thereby facilitating installation and detachment of the food tray 100 in the vacuum chamber 210 of the vacuum sealer 600.

In some embodiments, the base plate 1 and the peripheral wall 2 are integrally formed of metal or plastic. Using an integral molding method can reduce manufacturing costs.

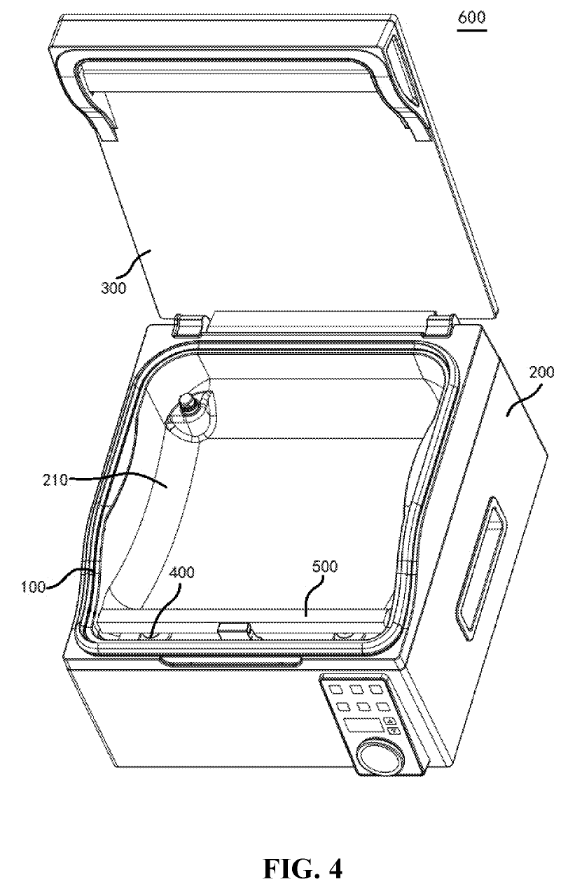

As shown in FIG. 4, the vacuum sealer 600 according to some other embodiments of the present disclosure includes a main housing 200, a lid 300, two conductive columns 400, a heating bar 500, and the food tray 100. The main housing 200 supplies power to the heating bar 500 through the conductive columns 400. The vacuum bag can be evacuated within the vacuum chamber 210 of the main housing 200 and then heat-sealed by the heating bar 500, thereby achieving a heat-sealed vacuum packaging operation of the vacuum bag. During this process, any food that leaks is collected in the recessed portion 11 of the food tray 100, preventing it from flowing into the vacuum chamber 210.

The main housing 200 is provided with the vacuum chamber 210 therein. The lid 300 is installed on the main housing 200. The lid 300 is configured to open or close the vacuum chamber 210. The two conductive columns 400 are installed on the main housing 200. The upper end of each of the conductive columns 400 extends into the vacuum chamber 210. The heating bar 500 is disposed in the vacuum chamber 210. The food tray 100 is detachably installed in the vacuum chamber 210. The upper end of each of the conductive columns 400 passes through the first through hole 14 of the food tray 100 to electrically connect to the heating bar 500.

When the vacuum sealer 600 completes the heat-sealed vacuum packaging operation on the vacuum bag, the lid 300 is opened to take out the food tray 100 for cleaning. At this time, the vacuum chamber 210 can remain clean.

Due to the above-described structural arrangement, by providing the food tray 100 which is convenient to detach and clean, the internal cleanliness of the vacuum sealer 600 can be maintained.

The above are only preferred embodiments of the present disclosure. It should be pointed out that for those of ordinary skill in the art, several modifications and substitutions can be made without departing from the technical principles of the present disclosure. These modifications and substitutions should also be regarded as the protection scope of the present disclosure.

1. A food tray, for detachably installing in a vacuum chamber of a vacuum sealer, comprising a base plate and a peripheral wall formed by upwardly bending an outer edge of the base plate, wherein the base plate and the peripheral wall enclose to form a containment space for food, the base plate comprises a recessed portion formed by depressing a central area of the base plate downward, and an extended portion formed by extending outward from an outer edge of the recessed portion, the extended portion is provided with two first bosses formed by protruding upward, each of the first bosses is provided with a first through hole therein, an upper end of the first through hole is in communication with the containment space, and the first through hole is configured to allow a conductive column of the vacuum sealer to pass through, such that an upper end of the conductive column extends into the containment space.

2. The food tray according to claim 1, wherein the extended portion is provided with a second boss formed by protruding upward, the second boss is provided with a second through hole therein, one end of the second through hole is in communication with the containment space, and another end of the second through hole is configured for connecting to a vacuum pump of the vacuum sealer.

3. The food tray according to claim 2, wherein a bottom of the first boss and a bottom of the second boss are both higher than the outer edge of the recessed portion.

4. The food tray according to claim 1, wherein the peripheral wall is provided with a second through hole therein, one end of the second through hole is in communication with the containment space, and another end of the second through hole is configured for connecting to a vacuum pump of the vacuum sealer.

5. The food tray according to claim 1, wherein the food tray comprises a bag clip, and the bag clip is installed on an inner wall of the peripheral wall.

6. The food tray according to claim 1, wherein the food tray comprises a temperature sensor, and the temperature sensor is installed on the recessed portion.

7. The food tray according to claim 6, wherein the temperature sensor comprises a temperature sensing probe and an electrode located below and electrically connected to the temperature sensing probe, the temperature sensing probe is sealingly connected to the recessed portion, and the electrode extends downward through the recessed portion into the vacuum chamber.

8. The food tray according to claim 1, wherein the food tray comprises a load cell disposed in the vacuum chamber, and the load cell is installed on a bottom surface of the base plate.

9. The food tray according to claim 1, wherein an edge of the peripheral wall is bent inward to form a flange.

10. The food tray according to claim 1, wherein the base plate and the peripheral wall are integrally formed of metal or plastic.

11. A vacuum sealer, comprising:
a main housing provided with a vacuum chamber therein;
a lid installed on the main housing, wherein the lid is configured to open or close the vacuum chamber;
two conductive columns installed on the main housing, wherein an upper end of each of the two conductive columns extends into the vacuum chamber;
a heating bar disposed in the vacuum chamber; and
the food tray according to claim 1, wherein the food tray is detachably installed in the vacuum chamber, and the upper end of each of the two conductive columns passes through a respective first through hole of the food tray to electrically connect to the heating bar.

12. A vacuum sealer, comprising:
a main housing provided with a vacuum chamber therein;
a lid installed on the main housing, wherein the lid is configured to open or close the vacuum chamber;
two conductive columns installed on the main housing, wherein an upper end of each of the two conductive columns extends into the vacuum chamber;
a heating bar disposed in the vacuum chamber; and
the food tray according to claim 2, wherein the food tray is detachably installed in the vacuum chamber, and the upper end of each of the two conductive columns passes through a respective first through hole of the food tray to electrically connect to the heating bar.

13. A vacuum sealer, comprising:
a main housing provided with a vacuum chamber therein;
a lid installed on the main housing, wherein the lid is configured to open or close the vacuum chamber;
two conductive columns installed on the main housing, wherein an upper end of each of the two conductive columns extends into the vacuum chamber;
a heating bar disposed in the vacuum chamber; and
the food tray according to claim 3, wherein the food tray is detachably installed in the vacuum chamber, and the upper end of each of the two conductive columns passes through a respective first through hole of the food tray to electrically connect to the heating bar.

14. A vacuum sealer, comprising:
a main housing provided with a vacuum chamber therein;
a lid installed on the main housing, wherein the lid is configured to open or close the vacuum chamber;
two conductive columns installed on the main housing, wherein an upper end of each of the two conductive columns extends into the vacuum chamber;
a heating bar disposed in the vacuum chamber; and
the food tray according to claim 4, wherein the food tray is detachably installed in the vacuum chamber, and the upper end of each of the two conductive columns passes through a respective first through hole of the food tray to electrically connect to the heating bar.

15. A vacuum sealer, comprising:
a main housing provided with a vacuum chamber therein;
a lid installed on the main housing, wherein the lid is configured to open or close the vacuum chamber;
two conductive columns installed on the main housing, wherein an upper end of each of the two conductive columns extends into the vacuum chamber;
a heating bar disposed in the vacuum chamber; and
the food tray according to claim 5, wherein the food tray is detachably installed in the vacuum chamber, and the upper end of each of the two conductive columns passes through a respective first through hole of the food tray to electrically connect to the heating bar.

16. A vacuum sealer, comprising:
a main housing provided with a vacuum chamber therein;
a lid installed on the main housing, wherein the lid is configured to open or close the vacuum chamber;
two conductive columns installed on the main housing, wherein an upper end of each of the two conductive columns extends into the vacuum chamber;
a heating bar disposed in the vacuum chamber; and
the food tray according to claim 6, wherein the food tray is detachably installed in the vacuum chamber, and the upper end of each of the two conductive columns passes through a respective first through hole of the food tray to electrically connect to the heating bar.

17. A vacuum sealer, comprising:
a main housing provided with a vacuum chamber therein;
a lid installed on the main housing, wherein the lid is configured to open or close the vacuum chamber;
two conductive columns installed on the main housing, wherein an upper end of each of the two conductive columns extends into the vacuum chamber;
a heating bar disposed in the vacuum chamber; and
the food tray according to claim 7, wherein the food tray is detachably installed in the vacuum chamber, and the upper end of each of the two conductive columns passes through a respective first through hole of the food tray to electrically connect to the heating bar.

18. A vacuum sealer, comprising:
a main housing provided with a vacuum chamber therein;
a lid installed on the main housing, wherein the lid is configured to open or close the vacuum chamber;
two conductive columns installed on the main housing, wherein an upper end of each of the two conductive columns extends into the vacuum chamber;
a heating bar disposed in the vacuum chamber; and
the food tray according to claim 8, wherein the food tray is detachably installed in the vacuum chamber, and the upper end of each of the two conductive columns passes through a respective first through hole of the food tray to electrically connect to the heating bar.

19. A vacuum sealer, comprising:
a main housing provided with a vacuum chamber therein;
a lid installed on the main housing, wherein the lid is configured to open or close the vacuum chamber;
two conductive columns installed on the main housing, wherein an upper end of each of the two conductive columns extends into the vacuum chamber;
a heating bar disposed in the vacuum chamber; and
the food tray according to claim 9, wherein the food tray is detachably installed in the vacuum chamber, and the upper end of each of the two conductive columns passes through a respective first through hole of the food tray to electrically connect to the heating bar.

20. A vacuum sealer, comprising:
a main housing provided with a vacuum chamber therein;
a lid installed on the main housing, wherein the lid is configured to open or close the vacuum chamber;
two conductive columns installed on the main housing, wherein an upper end of each of the two conductive columns extends into the vacuum chamber;
a heating bar disposed in the vacuum chamber; and
the food tray according to claim 10, wherein the food tray is detachably installed in the vacuum chamber, and the upper end of each of the two conductive columns passes through a respective first through hole of the food tray to electrically connect to the heating bar.
